(19) United States
(12) Patent Application Publication
(10) Pub. No.: US 2007/0186169 A1
(43) Pub. Date: Aug. 9, 2007

(54) Methods and systems for testing network components

(76) Inventors: Glenn F. Osborne, Davis, CA (US); John A. Anderson, Citrus Heights, CA (US); Mark Wright, Colfax, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/352,116

(22) Filed: Feb. 9, 2006

(51) Int. Cl. G06F 15/177; G06F 9/44; G06F 15/173; H04L 12/26

(52) U.S. Cl. 715/734; 717/124; 709/223; 370/241

(57) ABSTRACT

Methods and systems for managing and testing networks.

### BACKGROUND OF THE INVENTION

This invention relates generally to testing of network components.

The information-communication industry is an essential element of today's society, which is relied upon heavily by most companies, businesses, agencies, educational institutions, and other entities, including individuals. As a result, information service providers such as telephone, cable, and wireless carriers, Internet Service Providers (ISPs) and utility companies all have the need to deploy effective systems suitable for servicing such a demand. The importance of such information service providers rapidly deploying new systems and system elements and altering their existing management systems to accommodate evolving business and network requirements as needed has been recognized in the prior art. For example, it has been recognized that information service providers desire the ability to integrate existing network equipment and systems with new elements and applications, customize existing systems and applications, and scale systems to accommodate growing networks and traffic volumes.

Network management and operations have become crucial to the competitiveness of communication companies, utilities, banks and other companies operating Wide Area Networks (WANS) of computer devices and/or other network types and devices, including SONET, Wireline, Mobile, etcetera. For instance, many companies currently use customized “legacy” network management systems (NMSs) and operations support systems (OSSs). Various implementations of NMSs/OSSs are available for managing networks and network elements.

The challenges faced by network service providers to reduce operating costs, increase revenue and attract and retain customers can best be met by streamlining network management and processes, bringing new services online quickly and delivering consistently high quality of service (QoS). To become efficient and profitable, organizations need simplified, automated, modular and flexible operations support systems to drive down costs and increase customer satisfaction.

In the non-automated environments, technicians are frequently dispatched to remote sites to test and diagnose the network. Much of that testing can be automated and performed remotely. This can result in large cost savings.

by saving on the time required to isolate problems at remote sites through automated testing. Through automated testing, problems may be localized to specific locations in the network, or to specific failed hardware.

A set of components that enable the user to manage and test complex network environments is presently available for network testing amd management. The set of components includes agent, gateways, a server including an expert system, and an object model including a database, and an object browser. The Agents monitor system resources and can be installed on a variety of operating systems. The gateways are rule-based components that run a variety of applications and manage working sessions to network devices and via SNMP, TCP/IP, CORBA, CMIP, Telnet, TL1, SQL, X.25 and other protocol agents. They monitor, decompose, analyze and respond to messages received from the devices and send commands or data in response to data analysis or user-generated commands. The server consists of a rule-based, object-oriented engine and supporting services that make up the heart of the system, which:
maintains the network model including inherited classes, attributes, objects, and relationships
performs all administration, security and logging tasks
diagnoses and responds to events and requests forwarded from the gateways and application interfaces
maintains the logical, physical and graphical state of the network elements
manages alerts, thresholds, polling, paging and trouble tickets
manages dialogs to send commands to the network elements.

The object model represents network, system, and service objects and relationships and is the storage site for the network configuration and rules. The storage site in the object model stores class definitions, attributes, objects and relationships that model the real world relationships at the element, network and service level. The user can extend and customize this model to meet his/her needs.

The Object Browser provides readymade graphical views of the databases. By displaying folders of network data and the alarm status of specific equipment, this component enables users to see relationships and launch actions, navigating easily through query results, including saved views.

Presently available sets of components to manage and test complex networks utilized managed objects to implement the tests and managed object attributes to obtain the test results. Since such managed objects and their attributes are stored in a database in the storage site for the object model, retrieval of the managed objects and the attributes does not happen in exactly real time.

Therefore, there is a need to provide sets of components to manage and test complex networks, where the sets of components has faster performance.

### BRIEF SUMMARY OF THE INVENTION

The needs for the invention set forth above as well as further and other needs and advantages of the present invention are achieved by the embodiments of the invention described hereinbelow.

In one embodiment, the system of this invention includes a rule-based component capable of interacting with network devices, an expert system component capable of analyzing and responding to information received from the rule-based component and of managing, through the rule-based component, communication with the network devices, a policy building/rule building component capable of instantiating events, and a user interface.

In one instance, the user interface of this invention includes a component capable of allowing instantiation of an event, another component capable of allowing selection of an event, yet another component capable of retrieving and displaying attributes of instantiated network events and a graphical object depicting a map, the map having icons representing network locations related to events. The instantiated events and the attributes are not stored in the database.

For a better understanding of the present invention, together with other and further needs thereof, reference is made to the accompanying drawings and detailed description and its scope will be pointed out in the appended claims.

### BRIEF DESCRIPTION OF THE SEVERAL VIEWS OF THE DRAWING

FIG. 1 is a schematic and graphical representation of an embodiment of the system of this invention;

FIG. 2 is a graphical representation of an embodiment of a user interface utilized in this invention;

FIG. 3 is a graphical representation of another embodiment of a user interface utilized in this invention;

FIG. 4 is a graphical representation of yet another embodiment of the user interface utilized in this invention;

FIG. 5 is a graphical representation of a further embodiment of the user interface utilized in this invention;

FIG. 6 is a graphical representation of one of the components in an embodiment of the user interface of this invention;

FIG. 7 is a graphical representation of another of the components in an embodiment of the user interface of this invention;

FIG. 8 is a graphical representation of yet another of the components in an embodiment of the user interface of this invention;

FIG. 9 is graphical representation of a further one of the components in an embodiment of the user interface of this invention;

FIG. 10 is a graphical representation of a graphical object displayed in an embodiment of the user interface of this invention;

FIG. 11 is graphical representation of yet a further one of the components in an embodiment of the user interface of this invention;

FIG. 12 is graphical representation of even yet a further one of the components in an embodiment of the user interface of this invention;

FIG. 13 is a graphical representation of another embodiment of the user interface of this invention;

FIG. 14 is a graphical representation of a further embodiment of the user interface of this invention; and

FIG. 15 represents a graphical schematic block diagram representation of the hardware components of an embodiment of the system of this invention.

### DETAILED DESCRIPTION OF THE INVENTION

Methods and systems for managing and testing networks are disclosed herein below.

The term “instantiation” is used herein in the manner used in object oriented software systems.

“Management policy,” as used herein, refers to a set of rules to administer, manage, and control access to network resources for controlling behavior of a network management system. (See, for example, Morris Sloman, POLICY DRIVEN MANAGEMENT FOR DISTRIBUTED SYSTEMS, Journal of Network and Systems Management, Plenum Press. Vol. 2 No. 4, 1994, RFC 3198 available at http://rfc.sunsite.dk/rfc/rfc3198.html and RFC 3060 available at http://rfc.sunsite.dk/rfc/rfc3060.html, of which are incorporated by reference herein.)

A “structured collection of data” as used herein includes, but is not limited to, lists, a structured arrangement containing of data, and other means for providing groupings of data.

“Component” as used herein refers to means for selecting options in graphical user interfaces (GUIS) such as, but not limited to, menus, pull down menus, dialog boxes, drag and drop between dialog boxes, and other selecting and input means (see, for example, C. Petzold, Programming Windows, ISBN 1-57231-995-X, Ch. 9, Ch. 10, Ch. 11, pp. 357-566).

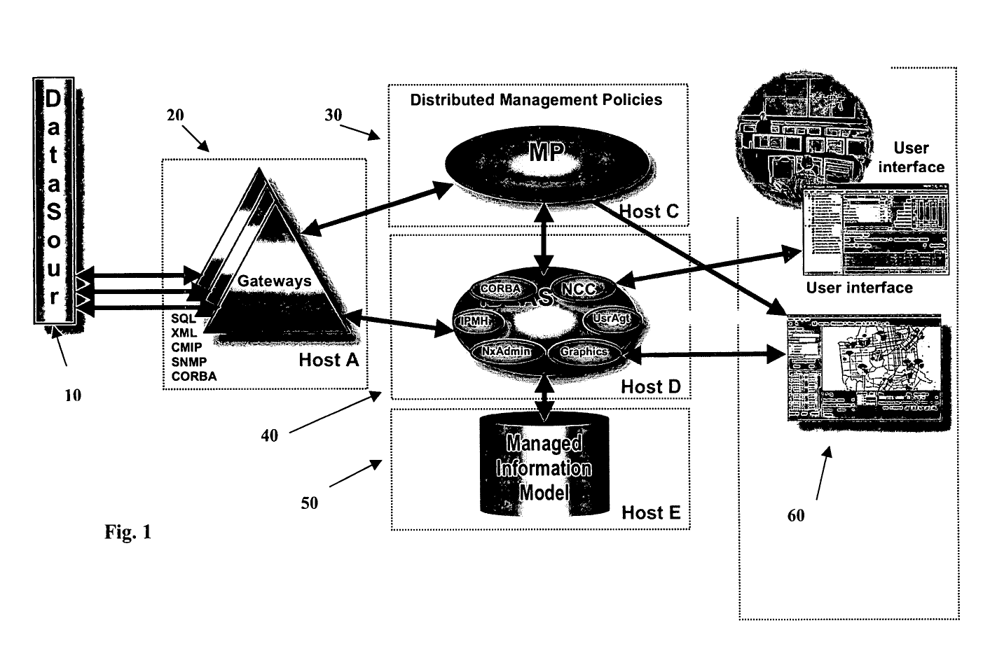

FIG. 1 depicts an embodiment of the system of this invention. Referring to FIG. 1, a network or a number of networks 10 is managed by the system comprised of a rule-based components 20 capable of interacting with network devices (herein below, the rule-based components are referred to as “gateways”), a server including an expert system component 40, where the expert system component is capable of analyzing and responding to information received on the networks and of managing communication with the networks, a policy building/rule building component 30 capable of instantiating events, the events having corresponding rules, the corresponding rules being applicable to managing and testing networks, and a user interface 60. An embodiment of the user interface 60 of this invention includes a component capable of allowing selection and instantiation of a network event, another component capable of retrieving and displaying attributes of instantiated network events, a graphical object depicting a map, the map having icons representing network locations related to an event. In the embodiment shown in FIG. 1, the gateways 20, the policy building component 30, the expert system 40 and an object model 50, which includes a database, are each located in different host systems. The host systems are operatively connected. In one embodiment, the operative connection is established by means of carrier waves, establishing a data network. Such a distributed system, in one embodiment, but not limited to only that embodiment, operates in a distributed system environments such as, but not limited to, CORBA.

The gateways may be implemented to receive and normalize messages for various types of network elements being managed. Normalizing involves translating (or mapping) a received incident (or message) into a suitable, consistent form (e.g., ASCII), which may be discern able within the entire management system. For instance, a Simple Network Management Protocol (SNMP) gateway process may be implemented for managing SNMP devices, and a Common Management Information Protocol (CMIP) gateway process may be implemented for managing CMIP devices. Thus, one or more gateway processes may be implemented for managing network elements that communicate in a particular communication protocol. Some management systems may desire information regarding the performance of network elements that is not provided through unsolicited messages generated by such network elements. In such case, gateways may be implemented to poll their respective network elements for particular information.(See, for example, co-pending patent application Ser. No. 09/770,427 entitled “SYSTEM AND METHOD FOR MANAGING A COMMUNICATION NETWORK UTILIZING STATE-BASED POLLING” and co-pending application Ser. No. 09/816,693 entitled “OBJECT -DRIVEN NETWORK MANAGEMENT SYSTEM ENABLING DYNAMICALLY DEFINABLE MANAGEMENT BEHAVIOR,” both of which are incorporated by reference herein.)

Depending on the amount of intelligence implemented within such gateway process, it may evaluate the performance of its respective network elements (e.g., based on unsolicited messages and responses to polling) and may trigger certain actions as necessary to manage the network elements. For instance, upon a fault message being received for a particular network element, the gateway process may generate an alert to a network administrator to-notify the network administrator of such fault condition. As a further example, once a gateway receives the variable values from the network element(s) in response to a poll, the gateway may then process such variable values to monitor the operation of the network element(s). For instance, if a gateway polls a network element for a response and fails to receive such a response, the gateway may provide an alert to the network administrator (e.g., by presenting an alert message to a computer workstation) notifying the network administrator of a problem with the network element. Similarly, if a gateway polls a network element for its available memory and determines that such network element has little or no memory available, the network administrator may be alerted as to such condition. In certain embodiments of the present invention, the management behavior of a gateway, such as alerting a user of particular conditions, may be defined by one or more user-defined policies implemented within the system of this invention by a component such the policy building component 30 of FIG. 1.

The system of various embodiments of the present invention is preferably object-driven. An example of such an object driven system is further described in co-pending patent application Ser. No. 09/816,693 entitled “OBJECT DRIVEN NETWORK MANAGEMENT SYSTEM ENABLING DYNAMICALLY DEFINABLE MANAGEMENT BEHAVIOR,” which is incorporated herein by reference. For instance, network elements and management behavior are preferably represented by objects within the management system. Such objects may be stored in a management information base (MIB) which may, for instance, be a memory for storing data for access by application program being executed on a computer system, the memory comprising a data structure stored in the memory, the data structure including information resident in a database used by the application program, or other suitable data storage management.

The ability of the expert system to model a hetereogeneous network of network elements, element management systems, network management systems, and business management systems, as well as to be able to interface into external inventory and circuit engineering systems and databases, and to model a circuit or other network entity in an object model, enables the ability to perform advanced root cause analysis and to perform tests to confirm that a specified condition exists in a network prior to dispatching based on rule-driven or policy defined actions.

According to an embodiment of the present invention, management policies may be defined in a manner that enables a user to configure the process flow of a management policy, such as is described further in co-pending application entitled “SYSTEM AND METHOD FOR FLEXIBLE PROCESSING OF MANAGEMENT POLICIES FOR MANAGING NETWORK ELEMENTS,” assigned Ser. No. 09/945,111, which is incorporated herein by reference. According to an embodiment of the present invention, policies are defined/represented in the fault management system as events or managed objects. Events, and their attributes, are not stored in a database while the managed objects are stored in the database in the managed information model 50.

The set of rules corresponding to an event may be defined by a user in accordance with an embodiment of the present invention by instantiating an event. In one embodiment, the policy (set of rules) may have several attributes that are definable by a user (e.g., via policy builder program such as that described in application Ser. No. 09/945,372, SYSTEM AND METHOD FOR DEFINING MANAGEMENT POLICIES FOR MANAGING NETWORK ELEMENTS, which is incorporated by reference herein.) In such embodiments, the user interface of this invention also includes yet another component capable of allowing a user to configure a network management policy and a further component capable of allowing editing of rules.

Although the embodiments of this invention described hereinabove include a set of rules corresponding to an event, embodiments are also possible in which in addition to the set of rules corresponding to an event, objects and object attributes are used. In such embodiments, the user interface also includes another component capable of allowing definition and instantiation of object classes (similar to an object factory).

In the embodiment described below, some of the components are conventional components. (Conventional components can be similar to those described in the NETeXPERT Assurance Technical Overview, Agilent Technologies, 5988-7543EN, August 2002, which is incorporated by reference herein.)

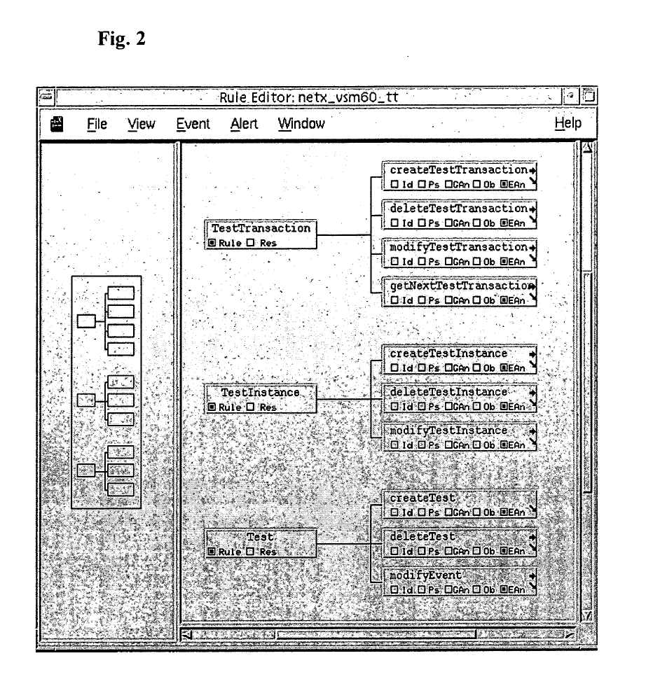

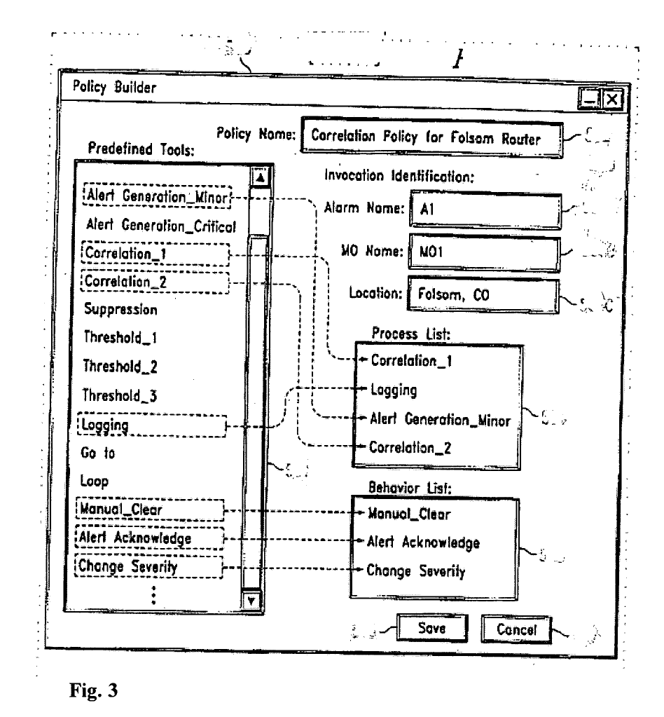

A user interface for the rule building component is shown in FIG. 2. Referring to FIG. 2, a user can, utilizing the interface shown therein, edit or define rules. A user interface for building policies (set of rules) is shown in FIG. 3 (a component capable of allowing a user to configure a network management policy). The user interfaces allowing policy building or allowing rule building allow the instantiation of an event, where the event has corresponding rules. Utilizing the interface shown in FIG. 3, a user can generate the set of rules corresponding to an event.

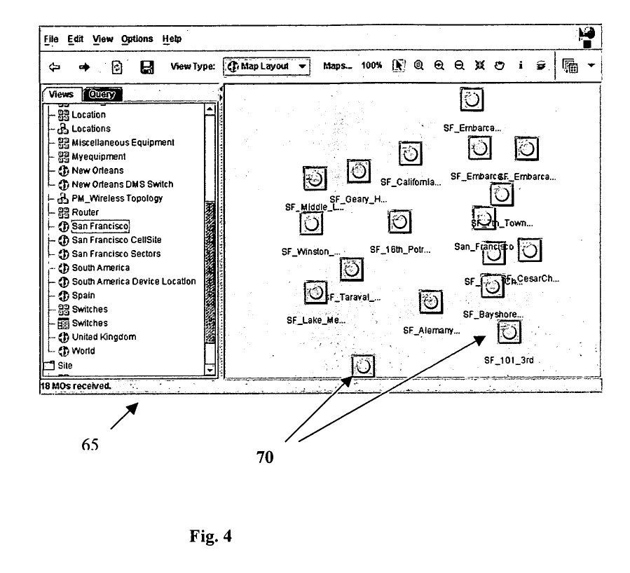

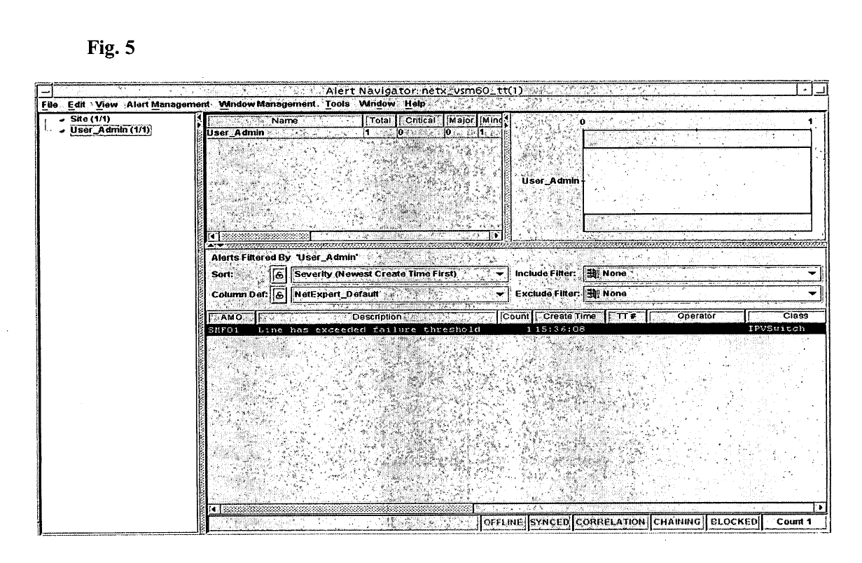

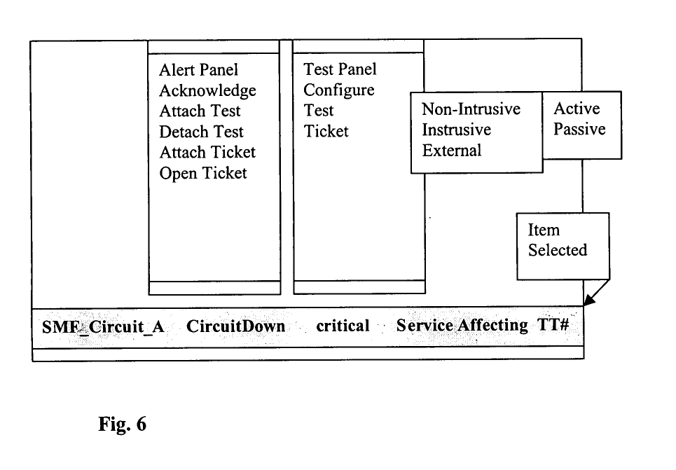

A user can initiate an event (a test) based on a specified or supplied parameters. A user can initiates a test on an alarm, possibly on a link down alert displayed in an interface such as shown in FIG. 4, an interface for navigating alerts, or FIG. 5, and interface 65 having a graphical object depicting a map, the map having icons representing locations related to events. A pulldown menu, which is one embodiment of a component capable of allowing selection of an event (although it should be noted that other embodiments are within the scope of this invention, is shown in FIG. 6. By selecting Attach Test, a user can initiate a test (an event).

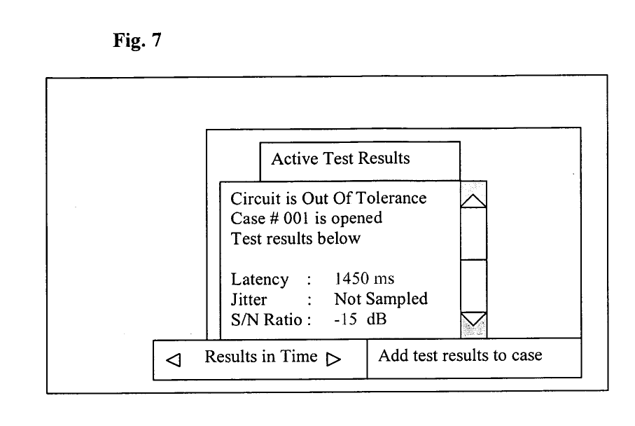

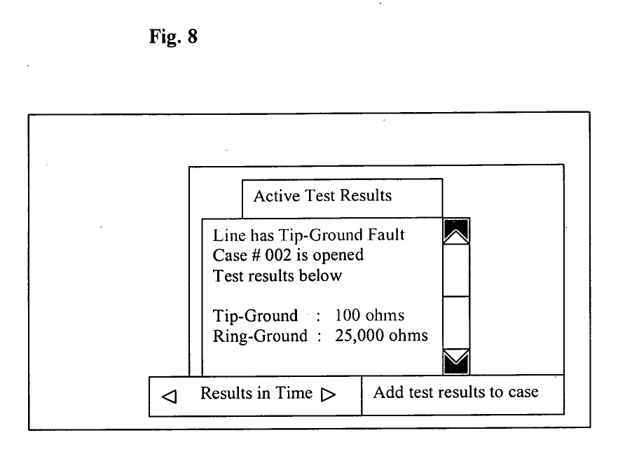

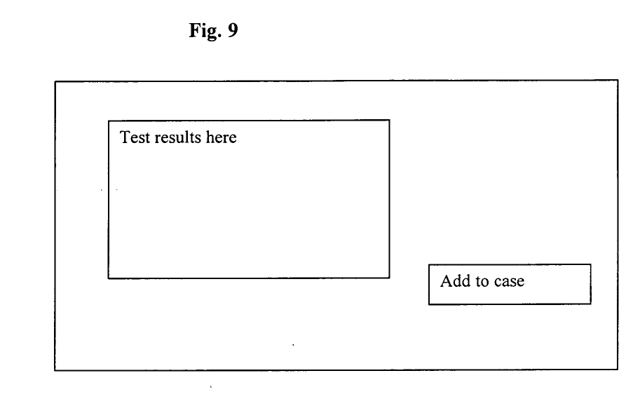

Parameters for the test are forwarded into the expert system, expert system determines routing to the network element for testing, and a dialog is initiated to the network element with the required parameters. By selecting Test, a user can retrieve test results (attributes). The user can also retrieve other test parameters (attributes) by causing a window (or a similar component), such as that shown in FIG. 7 or FIG. 8, to appear after the user takes an action such as, for example, activating one of the icons 70 on FIG. 5. In another instance, the user can input test results (selected ones of the attributes) utilizing a window such at that shown in FIG. 9, which can be caused to appear by, in one embodiment this invention not been limited to that embodiment, selecting a menu item made available by activating an icon 70.

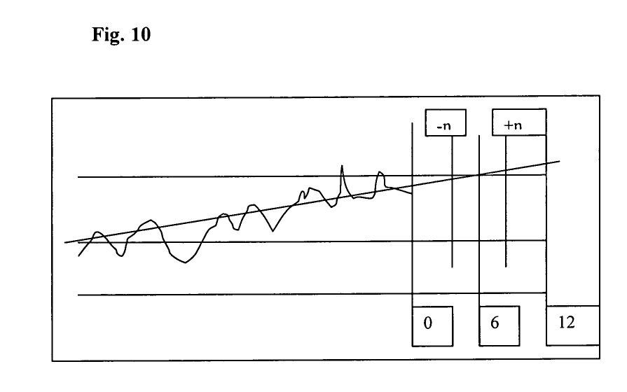

In another instance, the user interface includes another graphical object that depicts historical performance data for a network complement. For example, the user may elect to view historical performance data for the network component of interest and determined if the behavior that triggered the fault as a historical trend. A trend line may be displayed in the user interface. FIG. 10 shows an example of a graphical object in an interface of this invention, where the graphical object displays a trend line.

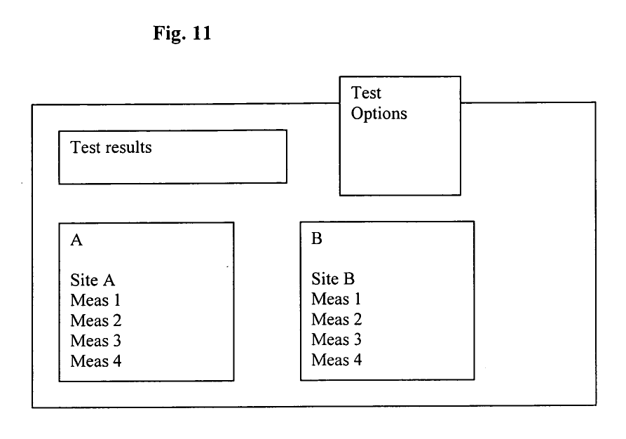

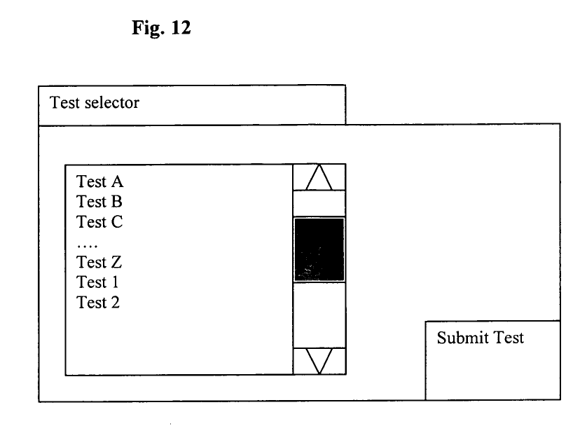

In another embodiment, the user can, through an interface such as that shown in FIG. 11, select test options and results. Using an interface such as that shown in FIG. 12, the user can select the test to be utilized and submitted.

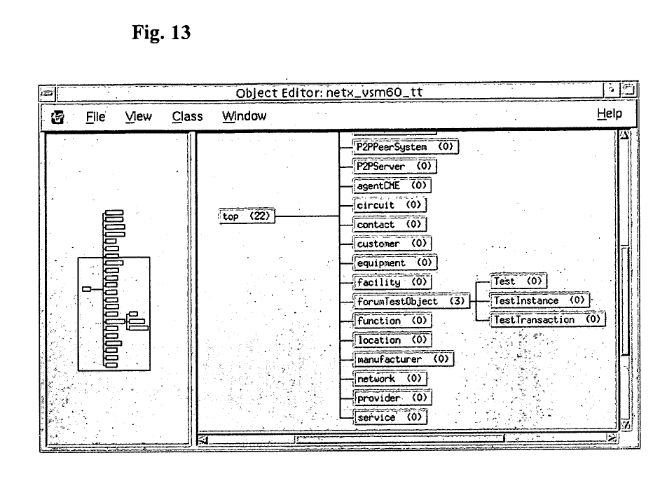

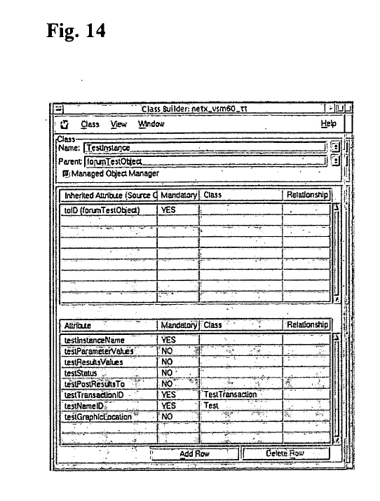

Tests can be configured through rules (events), dialogs, objects, and/or policies. In one embodiment, an Object Builder is used to create instances of classes, and to define the objects attributes. A Graphical User Interface which may be used to define classes, attributes, class attributes, class inheritance, object relationships, and managed objects is shown in FIG. 13. A Graphical User Interface for TestInstance class definition is shown in FIG. 14. Managed objects are stored in a database (in a management information base (MIB) in one for two of a there and say embodiment). The Object Builder component is used to create instances of classes, and to define the objects attributes. Objects may also be created using the rule building component/policy building component (30 in FIG. 1), and the object attributes are written to the database. Managed Object instances are stored in database tables stored in the MIB (database).

Event attributes might be used to communicate the values back to plug-in. Some existing plug-ins may exist. The plug in name in the existing plug-ins could be stored as an attribute.

In an embodiment of the system of this invention, the rule based component 20 capable of interacting with network devices 10, the expert system component 40, the policy building/rule building component 30, the user interface 60 and the component capable of allowing definition and instantiation of objects 50 are implemented in computer usable media having computer readable code embodied therein.

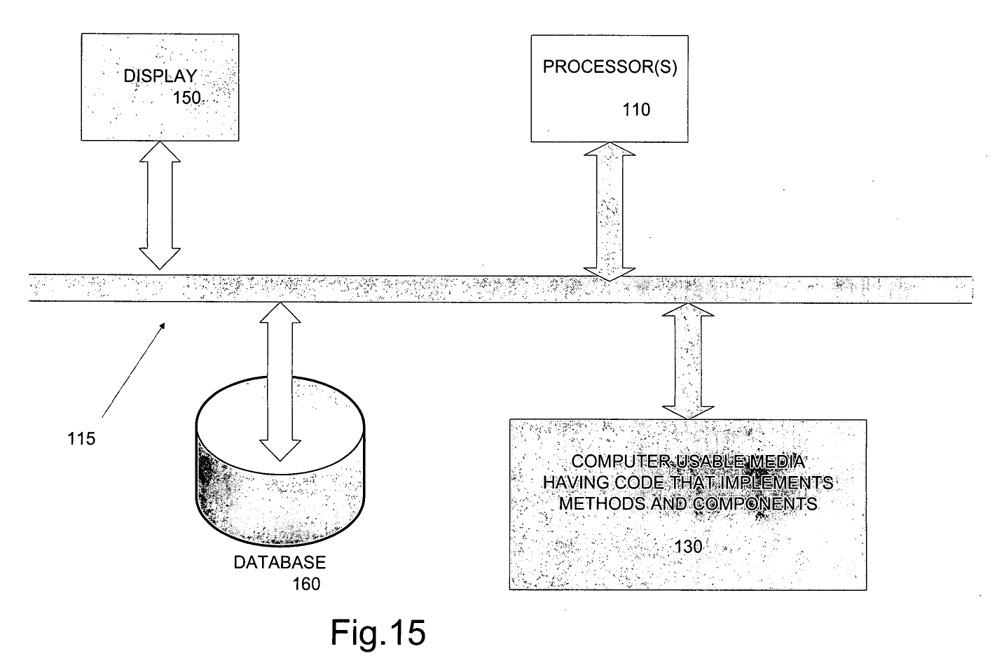

In the embodiment of the system of this invention shown in FIG. 15, one or more processors 110 are operatively connected to computer usable media 130 having computer readable code that implements the components and methods of this invention. A database (a memory for storing data for access by computer readable code being executed on the one or more processors 110, the memory comprising a data structure stored in the memory, the data structure including information resident in a database) 160 and one or more displays 150 are also operatively connected to the one or more processors 110 and to the computer usable media 130. The one or more displays 150, the one or more processors 110, the database 160 and the computer usable media 130 are operatively connected by means of a connection component 115 (the connection component may be, for example, a computer bus, physical connections for a network or a carrier wave).

In order to better describe the embodiments of this invention, the application of an embodiment is disclosed below. Using an interface such as that shown in FIGS. 2 and 3, a user can generate the set of rules corresponding to an event (thereby instantiating the event). A network link is isolated in the graphical interface 65, which has a graphical object depicting a map, the map having icons 70 representing locations related to events. Using the graphical interface 65, a user “drills down” to the specific point in a network where the circuit has failed. User can initiate a test (an event) using interface such as the shown in FIG. 6, which would appear as a pulldown menu in the “drill down” process. The instantiated test is communicated to the network. In one embodiment, the instantiated test is provided to an expert system 40 and the expert system 40 provides test parameters to the network. Both ends of a circuit, representing the link in the network, are tested. The test results are returned and received by the gateways 20. The test results and the test parameters (event attributes) can be displayed through the user interface 65. The test panel may display results of an active, extended, or short term test. The operator may select whether to insert the results into a trouble case. The operator may elect to view historical performance data on the object in question, and determine if a problem has a historical trend. The historical trend may have a trend line or service level baseline established for the object. Event attributes might be used to communicate the values back to the plug-in as an enhancement over the conventional use of managed object attributes. In one embodiment, the method of this invention allow user to post testing results and history into a trouble case for faster trouble isolation. In one embodiment, since the instantiated events and the event attributes are not stored in the database, the user interfaces of this invention make use of event attributes to display test results and other data in a near real-time testing environment.

The techniques described above may be implemented in one or more computer programs executing on a programmable computer including a processor, a storage medium readable by the processor (including, for example, volatile and non-volatile memory and/or storage elements), and, in some embodiments, also including at least one input device, and/or at least one output device. Program code may be applied to data entered using the input device (or user interface) to perform the functions described and to generate output information. The output information may be applied to one or more output devices.

Elements and components described herein may be further divided into additional components or joined together to form fewer components for performing the same functions.

Each computer program (computer readable code) may be implemented in any programming language, such as assembly language, machine language, a high-level procedural programming language, an object-oriented programming language, or a combination thereof. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable (computer usable) media include, for example, a floppy disk, a flexible disk, hard disk, magnetic tape, or any other magnetic medium, a CDROM, any other optical medium, punched cards, paper tape, any other physical medium with patterns of holes or other patterns, a RAM, a PROM, and EPROM, a FLASH-EPROM, any other memory chip or cartridge, a carrier wave, such as electromagnetic radiation or electrical signals, or any other medium from which a computer can read.

Although the invention has been described with respect to various embodiments, it should be realized this invention is also capable of a wide variety of further and other embodiments within the spirit and scope of the appended claims.

What is claimed is:

1. A user interface for displaying network conditions, the user interface comprising:
a component capable of allowing instantiation of an event;
another component capable of allowing selection of an event;
yet another component capable of retrieving and displaying attributes of instantiated events; and
a graphical object depicting a map, the map having icons representing locations related to events;
wherein said event has corresponding rules; and
wherein said instantiated event and said attributes are not stored in the database.

2. The user interface of claim 1 wherein said attributes comprise procedure names for managed object procedures.

3. The user interface of claim 1 further comprising:
a further component capable of allowing a user to input selected ones of said attributes.

4. The user interface of claim 1 further comprising:
another graphical object depicting historical performance data for a network component.

5. The user interface of claim 1 further comprising:
a further component capable of allowing a user to configure a network management policy; and
a further component capable of allowing editing of rules.

6. The user interface of claim 1 further comprising:
yet another component capable of allowing definition and instantiation of object classes.

7. A computing device and associated display, the computing device being programmed to display the user interface of claim 1.

8. A computer usable medium having computer readable code embodied therein, said computer readable code being capable of causing a computer to implement the user interface of claim 1.

9. A system for managing and testing networks, the system comprising:
a rule-based component capable of interacting with network devices;
an expert system component capable of analyzing and responding to information received from the rule-based component and of managing, through the rule-based component, communication with the network devices;
a policy building/rule building component capable of instantiating events; and
a user interface comprising:
a component capable of allowing instantiation of an event;
another component capable of allowing selection of an event;
yet another component capable of retrieving and displaying attributes of instantiated network events; and
a graphical object depicting a map, the map having icons representing network locations related to events;
said events having corresponding rules; and
wherein said instantiated events and said attributes are not stored in the database;
whereby said corresponding rules are applicable to managing and testing networks.

10. The system of claim 9 wherein said user interface further comprises:
a further component capable of allowing a user to configure a network management policy; and
another further component capable of allowing editing of rules.

11. The system of claim 9 wherein said rule-based component, said expert system component, said policy building/rule building component, and said user interface are implemented in computer usable media having computer readable code embodied therein.

12. The system of claim 9 further comprising:
a memory for storing data for access by application program being executed on a computer system, said memory comprising a data structure stored in said memory, said data structure including information resident in a database used by said application program; and
wherein said user interface further comprises: yet another component capable of allowing definition and instantiation of object classes;
said instantiated object classes and attributes being stored in said database.

13. A method for managing and testing networks, the method comprising the steps of:
selecting an event, the event having corresponding rules;
instantiating the event;
communicating the instantiated event to a network;
receiving test results from the network; and
displaying event attributes/test results.

14. The method of claim 13 wherein the step of communicating the instantiated event to the network comprises the step of:
providing the instantiated event to an expert system;
providing, from the expert system, test parameters to the network.
